(19) United States
(12) Patent Application Publication
(10) Pub. No.: US 2007/0040958 A1
(43) Pub. Date: Feb. 22, 2007

(54) Protection sheet annealing apparatus and protection sheet annealing method

(76) Inventors: Jin-Sung Choi, Cheonan-si (KR); Seung-Mo Kim, Cheonan-si (KR); Jheen-Hyeok Park, Seongnam-si (KR)

Correspondence Address: CANTOR COLBURN, LLP, 55 GRIFFIN ROAD SOUTH, BLOOMFIELD, CT, 06002, US

(21) Appl. No.: 11/503,785

(22) Filed: Aug. 14, 2006

(30) Foreign Application Priority Data
Aug. 18, 2005 (KR) 2005-75715

(51) Int. Cl. G02F 1/1333

(52) U.S. Cl. 349/58

(57) ABSTRACT

An annealing apparatus and a method of annealing a protection sheet is provided. The annealing method includes disposing the protection sheet in a chamber and injecting high-pressure carbon dioxide (CO₂) gas into the chamber or heating the protection sheet at a predetermined temperature in the chamber. In the annealing method a crystalline phase of molecules in the protection sheet is changed to be an amorphous phase of molecules by such that the protection sheet has a refractive index with substantially the same distribution.

This application claims priority to Korean Patent Application No. 2005-75715, filed on Aug. 18, 2005, and all the benefits accruing therefrom under 35 U.S.C. §119, the contents of which is hereby incorporated herein by reference in its entirety.

### BACKGROUND OF THE INVENTION

1. Field of the Invention

The present invention relates to an apparatus and a method for annealing a protection sheet. More particularly, the present invention relates to an apparatus and a method for annealing a protection sheet capable of enhancing display quality of a display device.

2. Description of the Related Art

Generally, a liquid crystal display (LCD) apparatus is a type of a flat display apparatus displaying image data by using liquid crystal. The LCD apparatus has advantages such as thin thickness, light weight, low driving voltage and power consumption, in comparison with other types of flat display apparatuses. Therefore, the LCD apparatus is widely used.

The LCD apparatus includes an LCD panel having a thin-film transistor (TFT), a color filter substrate facing the TFT substrate, and a liquid crystal layer disposed between the TFT substrate and the color filter substrate. The liquid crystal layer changes light transmissivity. Since the LCD panel is not a luminous element, which can emit light by itself, the LCD apparatus has a backlight assembly providing light to the LCD panel.

Generally, the backlight assembly includes a lamp and a light-guide plate. The lamp is disposed adjacent to the light-guide plate and emits the light. The light-guide plate guides the light emitted by the lamp toward the LCD panel. The light-guide plate includes a light-incident surface, a light-reflecting surface and a light-exiting surface. The light enters the light-guide plate through the light-incident surface. The light that enters the light-guide plate is reflected by the light-reflecting surface. The light that is reflected by the light-reflecting surface exits from the light-guide plate toward the LCD panel through the light-exiting surface. The light-exiting surface may have a prism pattern having a plurality of prisms formed thereon.

When the light-guide plate having the prism pattern is used, an additional prism sheet is unnecessary and luminance increases by enhancing a converging rate. However, the light-guide plate having the prism pattern formed thereon needs a protection sheet on the light-guide plate to protect the prism pattern.

When the backlight assembly having the above structure is assembled into the LCD device, a reddish phenomenon, in which red stripes are displayed by the LCD device, occurs. Therefore, the display quality of the LCD apparatus deteriorates.

### SUMMARY OF THE INVENTION

An exemplary embodiment provides an annealing apparatus for a protection sheet, through which display quality is enhanced.

An exemplary embodiment also provides a method of annealing the protection sheet, through which the display quality is enhanced.

In an exemplary embodiment of an annealing apparatus, the annealing apparatus for the protection sheet includes a winding roller, a chamber and a gas injection part. The winding roller winds the protection sheet, and a chamber internally receives the protection sheet. The gas injection part injects high-pressure carbon dioxide (CO₂) gas for annealing the protection sheet into the chamber.

In another exemplary embodiment of an annealing apparatus, the annealing apparatus for the protection sheet includes a winding roller, a chamber and a heat source. The winding roller winds the protection sheet, and a chamber internally receives the protection sheet. The heat source applies heat with a predetermined temperature for annealing into the chamber.

In an exemplary embodiment of an annealing method, the annealing method for the protection sheet includes disposing the protection sheet in a chamber and injecting high-pressure carbon dioxide (CO₂) gas into the chamber.

In an exemplary embodiment of an annealing method the annealing method for the protection sheet includes disposing the protection sheet in a chamber and applying heat with a predetermined temperature to the protection sheet in the chamber.

In an exemplary embodiment, a crystalline phase of molecules in the protection sheet is relaxed to be an amorphous phase of molecules by an annealing process and the annealed protection sheet has a refractive index with substantially the same distribution.

### BRIEF DESCRIPTION OF THE DRAWINGS

The above and other features and advantages of the present invention will become more apparent by describing in detailed example embodiments thereof with reference to the accompanying drawings, in which:

FIG. 1 is a perspective view illustrating an exemplary embodiment of a liquid crystal display (LCD) apparatus having a protection sheet manufactured by an apparatus and a method according to an example of the present invention;

FIG. 2 is an exemplary embodiment of a cross-sectional view taken along line I-I′ in FIG. 1;

FIG. 3 is a view illustrating an exemplary embodiment of a stretching process performed by an apparatus for a protection sheet in FIGS. 1 and 2;

FIG. 4 is a plan view illustrating an exemplary embodiment of a reddish phenomenon due to the protection sheet in FIG. 3;

FIG. 5 is a view illustrating an exemplary embodiment of a crystalline phase of D area in FIG. 4;

FIG. 6 is a view illustrating an exemplary embodiment of a protection sheet annealing apparatus according to the present invention;

FIG. 7 is a view illustrating an exemplary embodiment of an amorphous phase transformed by the annealing apparatus in FIG. 7; and

FIG. 8 is a view illustrating another exemplary embodiment of a protection sheet annealing apparatus according to the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, it can be directly on or connected to the other element or layer or intervening elements or layers may be present. In contrast, when an element is referred to as being “directly on” or “directly connected to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “upper” relative to other elements or features would then be oriented “lower” relative to the other elements or features. Thus, the term “upper” can encompass both an orientation of above and below. The device may be otherwise oriented (rotated 90 degrees or at other orientations) and the spatially relative descriptors used herein interpreted accordingly.

The terminology used herein Is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of legions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

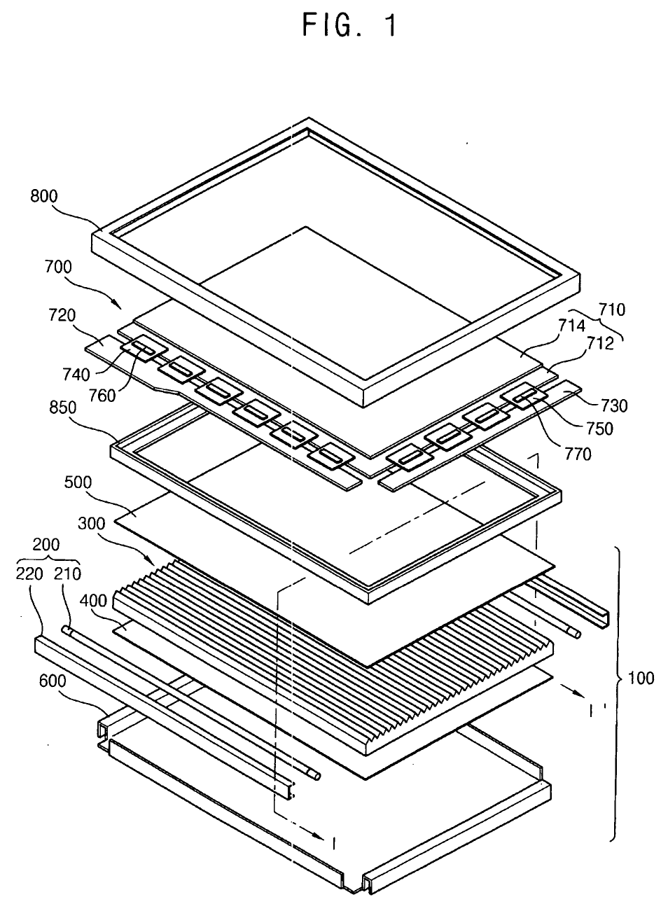

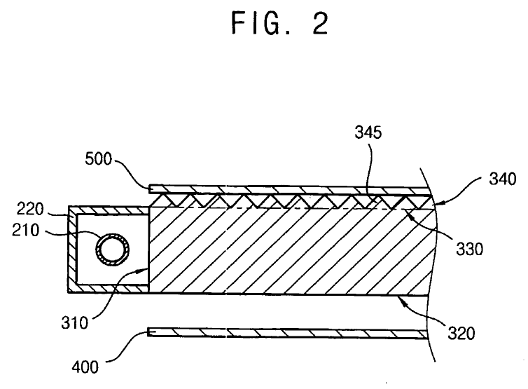

FIG. 1 is a perspective view illustrating an exemplary embodiment of a liquid crystal display (LCD) apparatus having a protection sheet manufactured by an apparatus and a method according to the present invention, and FIG. 2 is an exemplary embodiment of a cross-sectional view taken along line I-I′ in FIG. 1.

Referring to FIGS. 1 and 2, an LCD apparatus includes a backlight assembly 100, a display unit 700 and a top chassis 800. The backlight assembly 100 provides the display unit 700 with light. The display unit 700 displays images by using the light provided from the backlight assembly 100. The top chassis 800 fixes the display unit 700 to the backlight assembly 100.

The backlight assembly 100 includes a lamp unit 200, a light-guide plate 300, a reflective sheet 400 and a protection sheet 500. The backlight assembly 100 further includes a receiving container 600 and a plurality of optical sheets (not shown). The receiving container 600 sequentially receives a reflective sheet 400, the light-guide plate 300, the lamp unit 200 and the protection sheet 500.

The lamp unit 200 includes a lamp 210 and a lamp cover 220. The lamp unit 200 may be disposed at both a first side and a second side of the light-guide plate 300, the first and second sides being opposite to each other. Alternatively, the lamp unit 200 may be disposed at only one of the first and second sides of the light-guide plate 300.

At least one lamp 210 is disposed inside the lamp cover 220. The lamp 210 emits the light in response to power applied by an external inverter (not shown). In exemplary embodiments, a cold cathode fluorescent lamp (CCFL) having a thin and long cylindrical shape may be employed as the lamp 210. In alternative exemplary embodiments, an external electrode fluorescent lamp (EEFL) having an electrode disposed on outer surfaces of both end portions thereof may be employed as the lamp 210.

The lamp cover 220 encloses three surfaces of the lamp 210 and protects the lamp 210. The lamp cover 220 has portions arranged to define an opening towards the light guide plate 300. The lamp cover 220 may include a material with a high reflectivity. In alternative exemplary embodiments, a reflective material with a high reflectivity may be coated on an inner surface of the lamp cover 220. The lamp cover 220 reflects the light emitted from the lamp 210 toward the light-guide plate 300, and enhances light-using efficiency.

The light-guide plate 300 changes a direction of a path of light generated from the lamp unit 200, and transmits the light in a predetermined direction. In exemplary embodiments, the light-guide plate includes a transparent material to transmit the light. In an exemplary embodiment, the light-guide plate includes a polymethyl methacrylate (PMMA).

Referring to FIG. 2, the light-guide plate 300 includes a light-incident surface 310, a light-reflecting surface 320 and a light-exiting surface 330. The light emitted by the lamp 210 enters the light-guide plate 300 through the light-incident surface 310. The light-reflecting surface 320 Extends from a first side of the light-incident surface 310. The light-exiting surface :330 extends from a second side of the light-incident surface 310, and is opposite to the light-reflecting surface 320.

The light-exiting surface 330 of the light-guide plate 300 has a prism pattern 340 formed thereon. The prism pattern 340 protrudes from an upper surface of the light-exiting surface 330 to have a predetermined height. Moreover, the prism pattern 340 has a plurality of prisms 345 extending substantially parallel with the lamp 210 and being adjacent to each other. In exemplary embodiments, a cross-section of the prisms 345 has a substantially triangular shape. In alternative exemplary embodiments, the cross-section of the prisms 345 may be a polygonal shape or a convex lens shape. The prisms 345 in the prism pattern 340 may be deformed due to stresses caused by a high temperature and pressure.

The reflective sheet 400 is disposed under the light-reflection surface 320 of the light-guide plate 300. The reflection sheet 400 reflects the light leaked from the light-reflection surface 320 of the light-guide plate 300 toward the light-guide plate 300. Light that is reflected by the reflection sheet 400 enters the light-guide plate 300. In exemplary embodiments, the reflection sheet 400 may include a high-reflectivity material. In an exemplary embodiment, the reflection sheet 400 includes polyethylene terephthalate (PET) or polycarbonate (PC).

The protection sheet 500 is disposed over the light-exiting surface 330 of the light-guide plate 300, and protects the prisms 345 of the prism pattern 340. As in the illustrated embodiment, since the prisms 345 of the prism pattern 340 have sharp and pointed edges, the optical sheet may be damaged when the light-guide plate 300 and the optical sheet are compressed. Therefore, the protection sheet 500 is disposed between the light-guide plate 300 and the optical sheet, and prevents damage to the optical sheet. In an exemplary embodiment, the protection sheet 500 includes PET material or PC material.

In exemplary embodiments, the protection sheet 500 may be manufactured through a drying process, a melting process, a rapid cooling process, a stretching process, a crystallizing process and/or a winding process. Before transferred to an extrusion-molding machine, a polymer chip is fully dried to prevent from being dissolved in the melting process. After the drying process, the polymer chip is transferred to the extrusion-molding machine and is extruded into a mold. The melted polymer passes through a series of filters and impurities thereof are significantly reduced or essentially eliminated. The melted polymer, extruded due to pressure from the extrusion-molding machine, passes through a cylindrical-shaped mold with an optimized gap, and then is transformed to have a film shape. The film-shaped polymer (hereinafter referred to as protection sheet) is rapidly cooled down by cool water from a water tank. The cooled protection sheet is stretched through the stretching process, to have predetermined mechanical properties. In the stretching process, the cooled protection sheet is stretched both in a vertical direction (MD) and in a horizontal direction (TD).

A heat treatment process may be performed to enhance tensile strength and dimensional stability of the protection sheet. The heat-treated protection sheet is delivered into the winding process through which the protection sheet is wound by a take-up apparatus, and finally the heat-treated protection sheet 500 is produced.

Referring again to FIG. 1, the display unit 700 includes an LCD panel 710, a source printed circuit board (PCB) 720 and a gate PCB 730. The source PCB 720 and the gate PCB 730 provide a driving signal to drive the LCD panel 710.

The driving signal provided by -the source PCB 720 and gate PCB 730, is applied to the LCD panel 710 through a data flexible circuit film 740 and a gate flexible circuit film 750. In an exemplary embodiment, a tape carrier package (TCP) or a chip-on-film (COF) may be employed as the data flexible circuit film 740 and the gate flexible circuit film 750.

The data flexible circuit film 740 and the gate flexible circuit film 750 further include a data driving chip 760 and a gate driving chip 770, respectively. The data driving chip 760 and the gate driving chip 770 control a driving signal timing to properly apply the driving signal provided by the source PCB 720 and gate PCB 730 to the LCD panel 710.

The LCD panel 710 includes El thin-film transistor (TFT) substrate 712, a color filter substrate 714 and liquid crystal (not shown). The color filter substrate 714 is disposed to face the TFT substrate 712 and is combined with the TFT substrate 712. The liquid crystal (not shown) is disposed between the TFT substrate 712 and the color filter substrate 714.

The TFT substrate 712 may be a transparent glass substrate having a plurality of switching elements TFT (not shown) formed thereon in a matrix form. A data line is electrically connected to a source terminal of one of the switching elements TFT, and a gate line is electrically connected to a gate terminal of one of the switching elements TFT. A pixel electrode including a transparent conductive material is electrically connected to a drain terminal of one of the switching elements TFT.

The color filter substrate 714 faces the TFT substrate 712 and is separated from the TFT substrate 712 by a predetermined distance. In exemplary embodiments, the color filter substrate 714 has red-green-blue (RGB) pixels formed through a thin-film process, and displays a predetermined color by the light passing through the RGB pixels. The color filter substrate 714 further includes a common electrode including a transparent conductive material.

When power is applied to the gate terminal of the switching element TFT, the switching element TFT is turned on, so that an electrical field is induced between the pixel electrode and the common electrode. The induced electrical field changes an arrangement of liquid crystal molecules of the liquid crystal disposed between the TFT substrate 712 and the color filter substrate 714. Then, a transmissivity of the light provided from the backlight assembly 100 is adjusted according to the change of the array of the liquid crystal molecule, and a gradation of the image may be displayed.

The source PCB 720 is connected to a portion (side) of the TFT substrate 712 through the data flexible circuit film 740. The gate PCB 730 is connected to another portion (side) of the TFT substrate 712 through the gate flexible circuit film 750. Therefore, the source PCB 720 and gate PCB 730 generate and output a data signal and a gate signal to drive the LCD panel 710, respectively.

The data signal controls a voltage of the pixel electrode formed on the TFT substrate 712, and is applied to the data line through the data flexible circuit film 740. The gate signal controls the switching element TFT that is electrically connected to the gate line formed on the TFT substrate 712, and applied to the gate line through the gate flexible circuit film 750. The TFT substrate 712 has conductive lines (not shown) formed thereon to connect the data flexible circuit film 740 and the gate flexible circuit film 750 to the TFT substrate 712.

The display unit 700 is disposed over or above the backlight assembly 100. In detail, the LCD panel 710 is received by an upper mold frame 850, to be ultimately disposed over the backlight assembly 100. The source PCB 720 is disposed under the receiving container 600 by bending of the data flexible circuit film 740.

The top chassis 800 surrounds an edge portion of the LCD panel 710 disposed over the backlight assembly 100 and is combined with the receiving container 600. The top chassis 800 reduces the occurrence or essentially prevents the LCD panel 710 from being damaged by external impacts and from being separated from the receiving container 600.

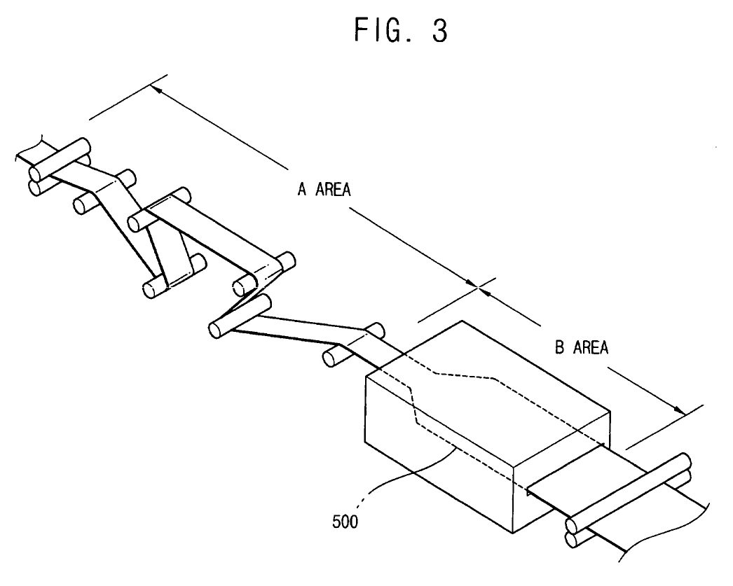

FIG. 3 is a view illustrating an exemplary embodiment of a stretching process performed by an apparatus for manufacturing a protection sheet in FIGS. 1 and 2, and FIG. 4 is an exemplary embodiment of a plan view illustrating a reddish phenomenon due to the protection sheet in FIG. 3.

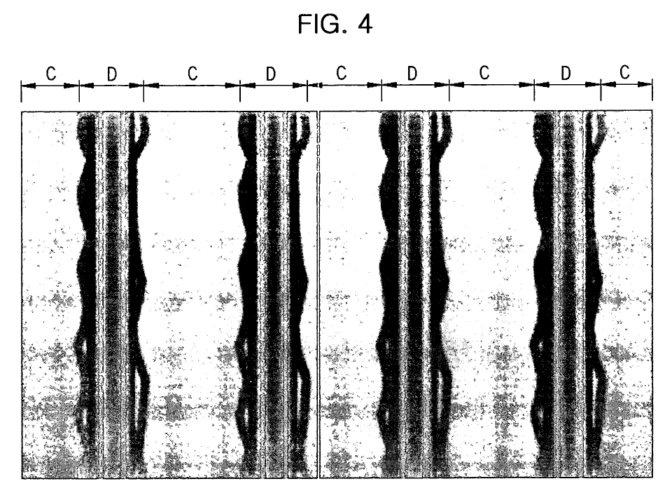

Referring to FIG. 3, an apparatus for manufacturing a protection sheet vertically (or longitudinally) stretches the protection sheet 500 in an A area and the apparatus horizontally (or transversely) stretches the protection sheet 500 in a B area. In stretching the protection sheet 500, a force applied to the protection sheet 500 may not uniform throughout all regions so that the protection sheet 500 is not uniformly stretched throughout all regions. When the LCD apparatus employs the protection sheet 500 that is not uniformly stretched, the reddish phenomenon, in which red lines are displayed as in FIG. 4, occurs.

The reddish phenomenon occurs according to a variation of a refractive index due to a non-uniform stretching of the protection sheet 500.

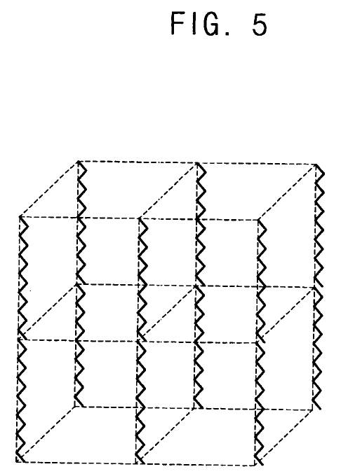

Table 1 shows experimental results on a difference of a refractive index between a C area and a D area in FIG. 4, and FIG. 5 is a view illustrating a crystalline phase of the D area in FIG. 4.

TABLE 1

| | C AREA | | | D AREA | | |
|---|---|---|---|---|---|---|
| | N_md | N_td | Δ(md − td) | N_md | N_td | Δ(md − td) |
| 1 | 1.6475 | 1.6735 | 0.0260 | 1.6470 | 1.6750 | 0.0280 |
| 2 | 1.6470 | 1.6730 | 0.0260 | 1.6470 | 1.6748 | 0.0278 |
| 3 | 1.6465 | 1.6730 | 0.0265 | 1.6460 | 1.6751 | 0.0291 |
| 4 | 1.6462 | 1.6735 | 0.0270 | 1.6460 | 1.6750 | 0.0290 |
| 5 | 1.6461 | 1.6734 | 0.0272 | 1.6460 | 1.6752 | 0.0292 |
| 6 | 1.6461 | 1.6735 | 0.0274 | 1.6455 | 1.6756 | 0.0301 |
| 7 | 1.6460 | 1.6735 | 0.0274 | 1.6455 | 1.6755 | 0.0300 |
| 8 | 1.6460 | 1.6735 | 0.0275 | 1.6455 | 1.6745 | 0.0291 |
| 9 | 1.6460 | 1.6735 | 0.0275 | 1.6452 | 1.6755 | 0.0303 |
| 10 | 1.6460 | 1.6736 | 0.0276 | 1.6450 | 1.6756 | 0.0306 |
| A | 1.6464 | 1.6734 | 0.0270 | 1.6459 | 1.6752 | 0.0294 |

Table 1 shows a refractive index N_md according to a vertical stretch MD, a refractive index N_td according to a horizontal stretch TD and a difference Δ(md-td) between the refractive index N_md and N_td. Each of the refractive index N_md, the refractive index N_td and the difference A(md-td) is measured in ten different points of both the C area without the reddish phenomenon and the D area with the reddish phenomenon.

An average value A of the difference Δ(md-td) between the refractive index N_md and N_td in the C area, is about 0.0270. The average value A of the difference Δ(md-td) between the refractive index N_md and N_td in the D area, is about 0.0294. Therefore, the average value A of the difference Δ(md-td) in the D area with the reddish phenomenon is larger than that in the C area without the reddish phenomenon.

Since macromolecules having the crystalline phase exist more in the D area with the reddish phenomenon than in the C area without the reddish phenomenon, the average values A of the difference A(md-td) differ from each other. The crystalline phase, as illustrated in FIG. 5, means that macromolecules are in a phase having a uniform arrangement.

Therefore, the reddish phenomenon may be eliminated by changing the crystalline phase formed in the D area into an amorphous phase such as formed in the C area, and thus changing the macromolecules in the C and D areas to be in substantially the same phase.

In an exemplary embodiment of the present invention, an annealing process is performed. The annealing process transforms the crystalline phase into the amorphous phase. The annealing process includes injecting carbon dioxide (CO₂) gas into a completed protection sheet 500 and/or applying heat to the completed protection sheet 500.

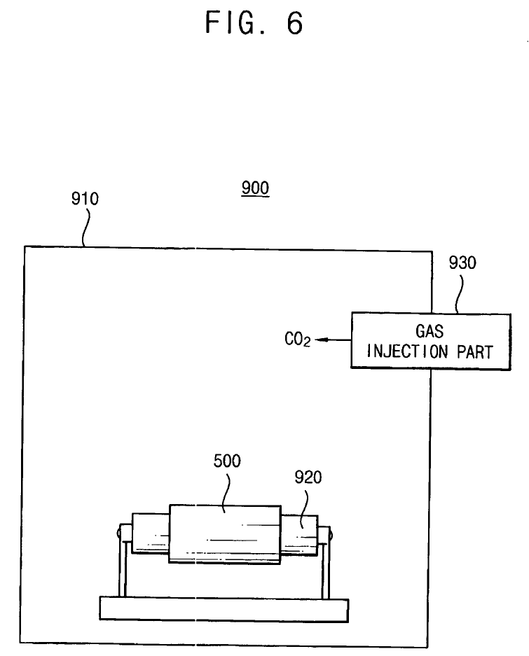

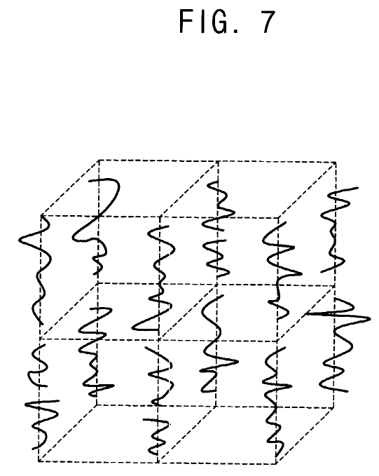

FIG. 6 is a view illustrating an exemplary embodiment of a protection sheet annealing apparatus according to the present invention, and FIG. 7 is a view illustrating an exemplary embodiment of an amorphous phase transformed by the annealing apparatus in FIG. 6. The exemplary embodiment of the protection sheet annealing apparatus illustrated in FIG. 6 an apparatus using carbon dioxide (CO₂) gas.

Referring to FIG. 6, a protection sheet annealing apparatus 900 includes a chamber 910 to anneal the protection sheet 500, a winding roller 920 and a gas injection part 930. The protection sheet 500 is wound on the winding roller 920 and a gas is injected into the chamber 910 substantially uniformly by the gas injection part 930. In an exemplary embodiment, the gas injection part 930 injects the carbon dioxide (CO₂) gas having a temperature about 30° C. into the chamber 910.

An exemplary embodiment of the annealing process using the annealing apparatus 900 is described as follows.

A winding process winding the protection sheet 500 on the winding roller 920 in the chamber 910 is performed. High-pressure carbon dioxide (CO₂) gas is injected into the chamber 910 by the gas injection part 930, and the protection sheet 500 is annealed for about 10 hours. The high-pressure carbon dioxide (CO₂) gas plays a role as a plasticizer inside of the macromolecules, and changes a glass transistion temperature of the macromolecules. The glass transistion temperature of the macromolecules is defined as a temperature at which molecules inside of a material having the macromolecules are activated and start to move.

In an exemplary embodiment where the protection sheet 500 includes PET or PC material, the high-pressure carbon dioxide (CO₂) gas plays a role as the plasticizer and decreases the glass transistion temperature of the PET or PC material so that free volume among macromolecule chains is expanded. Therefore, the macromolecule chains may move more easily, and small molecules may be easily diffused among the macromolecule chains. Finally, the crystalline phase is transformed into the amorphous phase as illustrated in FIG. 7.

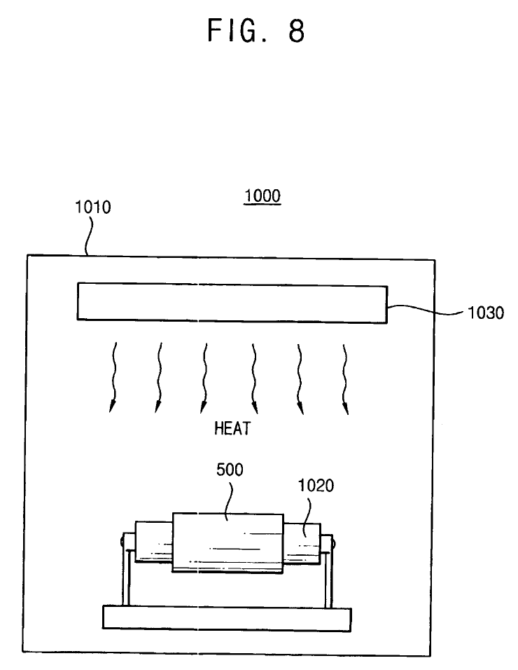

FIG. 8 is a view illustrating another exemplary embodiment of a protection sheet annealing apparatus according to the present invention. The exemplary embodiment of the annealing apparatus illustrated in FIG. 8 an apparatus using a heat treatment.

Referring to FIG. 8, the annealing apparatus 1000 includes a chamber 1010 to anneal the protection sheet 500, a winding roller 1020 and a heat source 1030, such as a heater. The protection sheet 500 is wound on the winding roller 1020, and heat at a predetermined temperature is applied to the chamber 1010 by the heat source 1030. In an exemplary embodiment, the heat source 1030 applies heat having a temperature between about 60° C. and about 80° C. to the protection sheet 500 for about 5 hours.

By applying the heat, the macromolecule chains may move more easily, and small molecules may be easily diffused among the macromolecule chains. Finally, the crystalline phase transforms into the amorphous phase as illustrated in FIG. 7.

The annealing process transforms the crystalline phase into the amorphous phase in the area where the reddish phenomenon occurs. Due to the transformation, the protection sheet 500 may have the amorphous phase over the whole area, and the difference Δ(md-td) between the refractive index N_md and the refractive index N_td may become uniform over the whole area. Advantageously, the LCD apparatus having the protection sheet 500 formed therein may eliminate the reddish phenomenon in which red stripes appear.

The illustrated exemplary embodiments of the present invention are described with reference to an LCD panel having the liquid crystal layer between the first substrate and the second substrate. However, the present invention can be applicable to other various display apparatuses having the backlight assembly of the present invention.

In an illustrated exemplary embodiment, the annealing process is performed by using carbon dioxide (CO₂) gas or heat at a predetermined temperature.

Through the annealing process, the crystalline phase of the protection sheet transforms into the amorphous phase, and the protection sheet has a uniform range of the refractive index.

Advantageously, the present invention may prevent the reddish phenomenon in which red stripes appear, and enhance display quality of the LCD apparatus.

Having described the example embodiments of the present invention and its advantage, it is noted that various changes, substitutions and alterations can be made herein without departing from the spirit and scope of the invention as defined by appended claims.

What is claimed is:

1. An apparatus for annealing a protection sheet disposed on a light-guide plate, the apparatus comprising:
a chamber receiving the protection sheet; and
a gas injection part injecting high-pressure carbon dioxide (CO₂) gas into the chamber.

2. The apparatus of claim 1, wherein a temperature of the carbon dioxide (CO₂) gas is about 30° C.

3. The apparatus of claim 1, further comprising a winding roller winding the protection sheet in the chamber.

4. An apparatus for annealing a protection sheet disposed on a light-guide plate, the apparatus comprising:
a chamber receiving the protection sheet; and
a heat source disposed in the chamber, the heat source heating the protection sheet at a predetermined temperature.

5. The apparatus of claim 4, wherein the predetermined temperature is between about 60° C. and about 80° C.

6. The apparatus of claim 4, further comprising a winding roller winding the protection sheet in the chamber.

7. A method of annealing a protection sheet disposed on a light-guide plate, the method comprising:
disposing the protection sheet in a chamber;
injecting high-pressure carbon dioxide (CO₂) gas into the chamber; and
annealing the protection sheet.

8. The method of claim 7, wherein a temperature of the carbon dioxide (CO₂) gas is about 30° C.

9. The method of claim 7, wherein the annealing is performed for about 10 hours.

10. A method of annealing a protection sheet disposed on a light-guide plate, the method comprising:
disposing the protection sheet in a chamber; heating the protection sheet at a predetermined temperature in the chamber; and
annealing the protection sheet.

11. The method of claim 10, wherein the predetermined temperature is between about 60° C. and about 80° C.

12. The method of claim 10, wherein the heating the protection sheet is performed for about 5 hours.

13. A method for annealing a protection sheet disposed on a light-guide plate of an LCD apparatus, the method comprising:
stretching the protection sheet in longitudinal and transverse directions; and
annealing the protection sheet and changing a molecular arrangement of the protection sheet.

14. The method of claim 13, wherein the annealing the protection sheet comprises:
disposing the stretched protection sheet in a chamber; and
injecting high-pressure carbon dioxide (CO₂) gas into the chamber.

15. The method of claim 13, wherein the annealing the protection sheet comprises:
disposing the stretched protection sheet in a chamber; and
applying heat with a predetermined temperature to the protection sheet in the chamber.

16. The method of claim 13, wherein the changing the molecular arrangement of the protection sheet comprises changing a crystalline phase having a uniform arrangement to an amorphous phase, such that the protection sheet has a refractive index with substantially the same distribution.
